(19) United States
(12) Patent Application Publication
(10) Pub. No.: US 2024/0184770 A1
(43) Pub. Date: Jun. 6, 2024

(54) CLIENT REFRESH

(71) Applicant: SAP SE, Walldorf (DE)

(72) Inventor: Wulf KRUEMPELMANN, Altlussheim (DE)

(21) Appl. No.: 18/060,807

(22) Filed: Dec. 1, 2022

(51) Int. Cl. G06F 16/23

(52) U.S. Cl. CPC G06F 16/2379; G06F 16/2365

(57) ABSTRACT

In some implementations, there is provided receiving, by a client refresh controller, an indication to refresh a client; in response to the received indication triggering the refresh of the client, the refresh comprising: selecting at least a first data table including client customization data for a client being refreshed; storing at least one user master address to a temporary table; in response to the selecting and storing, deleting at least the first table selected by the client refresh controller; in response to the deleting, retrieving the at least one user master address from the temporary table and inserting the at least one user master address into the client; copying a master workspace; and deploying the master workspace to the client via a transport request. Related systems, methods, and articles of manufacture are also disclosed.

### TECHNICAL FIELD

This disclosure relates generally to deployment technology including multi-cloud technology.

### BACKGROUND

Database management systems have become an integral part of many computer systems. For example, some systems handle hundreds if not thousands of transactions per second (which in-turn can generate over time a large volume of corresponding data). On the other hand, some systems perform very complex multidimensional analysis on data. In both cases, the underlying database may need to handle responses to queries very quickly in order to satisfy systems requirements with respect to transaction time. Given the complexity of these queries and/or their volume, the underlying databases face challenges in order to optimize performance including use of resources, such as memory and storage.

### SUMMARY

In some implementations, there is provided a computer-implemented method including receiving, by a client refresh controller, an indication to refresh a client; in response to the received indication triggering the refresh of the client, the refresh comprising: selecting, by the client refresh controller, at least a first data table including client customization data for a client being refreshed; storing, by the client refresh controller, at least one user master address to a temporary table; in response to the selecting and storing, deleting, by the client refresh controller, at least the first table selected by the client refresh controller; in response to the deleting, retrieving, by the client refresh controller, the at least one user master address from the temporary table and inserting the at least one user master address into the client; copying, by the client refresh controller, a master workspace; and deploying, by the client refresh controller, the master workspace to the client via a transport request.

In some variations, one or more of the features disclosed herein including the following features can optionally be included in any feasible combination. The client comprises a development client for a database instance and/or a test client for the database. The first data table including the client customization data is selected from a system landscape, wherein the client customization data is customized for or by an end-user of the client being refreshed. The at least one user master address identifies one or more user roles with respect to authorization to access data and perform activities for the client being refreshed. The first table is deleted from a system landscape, and wherein the at least one user master address is inserted into the client at the system landscape. In response to the deleting, at least a number range is copied into the client at a system landscape. The copying, by the client refresh controller, the master workspace further comprises copying the master workspace at a configuration tool, wherein the master workspace includes customizing information for the client. The method may further include importing the transport request into the client; refresh test data into the client; and handing over the client for use as a test client or a development client.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram illustrating an example of a system including a client refresh controller, in accordance with some embodiments;

FIG. 2 depicts another example of system including a multi-cloud environment and a quota management application, in accordance with some embodiments;

FIGS. 3A and 3B depict another example of a process for controlling a quota at a cloud service provider, in accordance with some embodiments; and

FIG. 4 depicts another example of a system, in accordance with some embodiments;

### DETAILED DESCRIPTION

In some systems, the system landscape may include several clients. For example, a system landscape may have a client for production where production software is used to provide a database management system or other type of application or service, another client may be used for testing of the software, and a third client may be used for development projects. And, these clients may be labeled or identified. For example, a client in the system landscape may be identified as client 000, which may correspond to a development client; another client in the system landscape may be identified as client 100, which may correspond to a customizing client; another client in the system landscape may be identified as client 111, which may correspond to a testing client.

After the end of a development project, an end-user customer or developer may decide if the development project (e.g., an improvement, modification, or new release for the database management system) was successful enough to deploy. If not successful enough to deploy, the development client of the system landscape may need to be refreshed to bring the development client to a baseline configuration to enable the development client to be used again for development. During a refresh of the development client, the client refresh might include deleting the entire client and rebuilding the development client, but deleting the development client and rebuilding it from scratch can be burdensome given the complexity of not only the software associated with for example the development client but also the configuration and other data (which in the case of a database management system can be very complex-leading to long rebuild times). To that end, there is provided a novel way to perform a client refresh clients into a baseline state.

Before providing additional details regarding the client refresh, the following provides an example of a system environment.

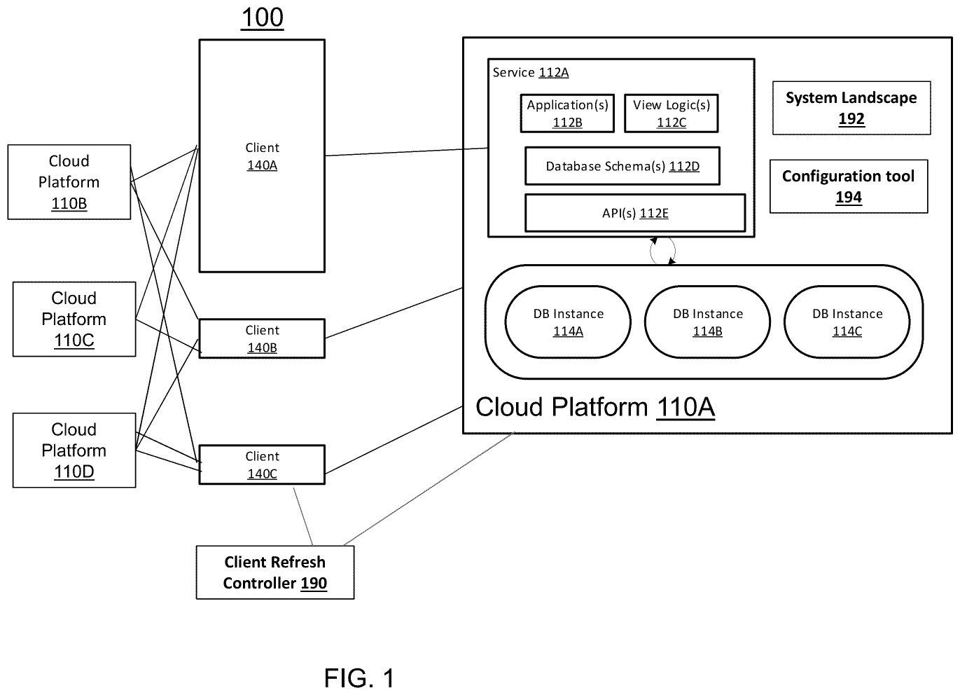

FIG. 1 depicts a diagram illustrating an example of a system 100 consistent with some implementations of the current subject matter. Referring to FIG. 1, the system 100 may include a plurality of cloud platforms 110A-D. Each of the cloud platforms may provide resources that can be shared among a plurality of tenants. For example, the cloud platforms 110A-D may be configured to provide a variety of services including, for example, software-as-a-service (SaaS), platform-as-a-service (PaaS), infrastructure as a service (IaaS), database as a service (DaaS), and/or the like, and these services can be accessed by one or more tenants (labeled clients) of the cloud platform. In the example of FIG. 1, the system includes a client refresh controller 190 to control the refresh of a client and a system landscape 192 and a configuration tool 194 which may provide a tool that allows configuring a configuration for a client and a workspace that stores a customized configuration for the client.

In the example of FIG. 1, the system 100 includes a first tenant 140A, a second tenant 140B, and a third tenant 140C, although other quantities of tenants (which as noted are labeled as tenants) may be implemented as well on the cloud platform 110A. A user may access the client, and the clients may each comprise a user device (e.g., a computer including an application such as a browser or other type of application). And, the clients may each access, via the Internet and/or other type of network or communication link(s), at least one of the services at a cloud platform, such as cloud platform 110A-D. In some implementations, each of the clients/tenants 140A-C represents a separate tenant at the cloud platform 110A for example, such that a tenant's data is not shared with other tenants (absent permission from a tenant). Alternatively, each of the tenants 140A-C may represent a single tenant at the cloud platform 110A, such that the tenants do share a portion of the tenant's data, for example.

The cloud platform 110A may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources.

In the case of a cloud platform being a so-called “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110A includes a service 112A, which is provided to for example the client 140A (or one of the other clients 140B). This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110A.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database 114A may be accessed as a service at a cloud platform, which may be the same or different platform from cloud platform 110A. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110A. Although the database instances are depicted at the same cloud platform 110A, one or more of the database instances may be hosted on another or separate platform (e.g., on-premise) and/or another cloud platform. Moreover, the service provided at the cloud platform may include other types of applications, such user interface applications, and the like.

The cloud platforms 110A-D may (as noted) be implemented using different technologies. As such, a system having heterogeneous cloud platforms may include for example, deployments at a SAP cloud, Microsoft Azure™, Amazon Web Services™, Google Cloud Platform™ data centers, a private data center, and/or the like. The heterogeneous cloud platform technology represents a multi-cloud system. In the case of database instances and/or their clients, some may be deployed at different private data centers (each of which may have different cloud platform technology, protocols, and the like), while some may be deployed at private data centers.

Moreover, the databases instances at the cloud platform may rely on the same or different storage or database technology. For example, a database management system instance may be an online transaction processing (OLTP) system using a relational database system. An example of an OLTP system is the SAP S/4HANA™ enterprise resource planning (ERP) system. Furthermore, the database management system instance may operate using for example the same or different storage technology, such as a row-oriented database system, a column-oriented database system, or a hybrid row-column store approach. Alternatively, or additionally, the database management system instance may be for example an online analytic processing (OLAP) system. Applications of OLAP systems include business reporting for sales, marketing, management reporting, business process management (BPM), budgeting, forecasting, financial reporting, and/or other types of analytics. An example of the OLAP system is the SAP BW/4HANA™ data warehouse solution, which can be used to for example answer multi-dimensional analytical (MDA) queries.

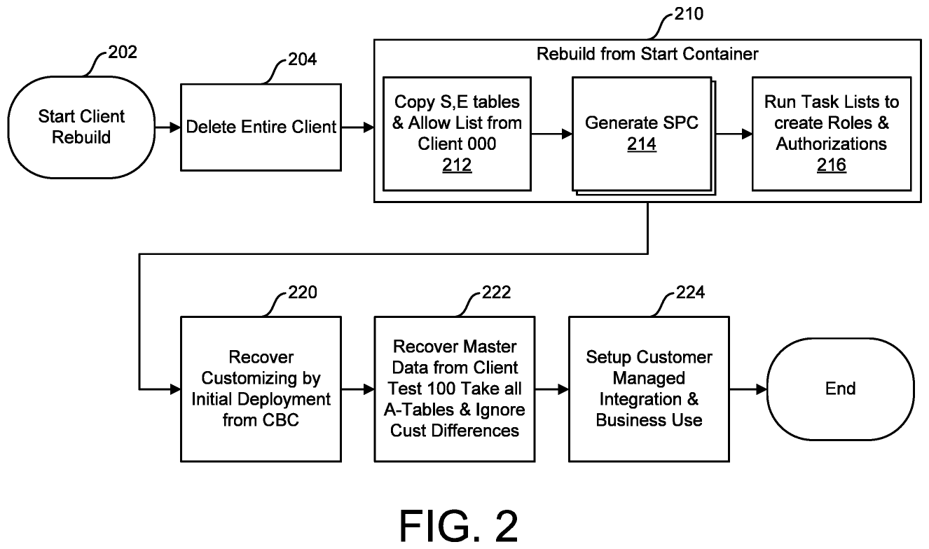

FIG. 2 depicts a process for refreshing a client, such as a development client or a test client, in accordance with some embodiments.

When the refresh (also referred to rebuild) of a client such as the development (or test) client is initiated, the entire client may, at 202-204, be deleted from the system landscape 192. The system landscape may include the systems (which includes clients such as development client, test client, etc.) that a given tenant (or user's) system may have installed, and these installed systems may be linked via transport routes among the systems to enable use and message exchanges via transport requests, for example. To illustrate, the system landscape may include at least one development system (with a customizing or development client where customizing or development may be performed), at least one quality assurance (QA) system (with a QA (or test) client where QA or test is performed), and at least one production system (with a production client where the actual production system is used in productive, operational use). For example, the development client of a database system instance may include software, configuration information (including customizations), and data (e.g., needed to operate the database management system instance). Likewise, the test client may represent a version of the development client being used for testing and QA before operation use as a production client.

At 210, the client is rebuilt from a container, such as a start container. To that end, the process includes copying at 212 data such as tables and other data needed to configure the client. For example, the copying of 212 may copy data such as S tables, E tables, and/or an allow list. The S table refers to a system table where a technical configuration of the system (e.g., application and master data for a database instance) is stored. The E table refers to a control table where an end-user customer is allowed to make changes (e.g., customizations to the system such as the development client) to a portion of the control table, while other portions cannot be changed by the end-user customer (e.g., reserved for changes by the developer of the database instance). The allow list refers to a list of tables that are “allowed” to be copied. The copy may be from a baseline client, such as a development client 000 in the example of FIG. 2, to a development (or test) client that is being refreshed.

The tables (e.g., database tables) of the system such as the database system instances may be classified by the system landscape to identify a class. Table 1 below depicts an example of the classes.

TABLE 1

| Class | Description |
|---|---|
| A | Refers to a database table that includes master data and transaction |
| | data |
| C | Refers to a customizing table, which may limit access to only the |
| | end-user/customer rather than a developer of the database system. |
| L | Refers to local data |
| G | Refers to a customizing table that can be modified by the end-user/ |
| | customer but not modifiable by the developer of the database |
| | system. |
| E | Refers to a control table, with a portion that can be modified by |
| | the end-user/customer and a portion that cannot (e.g., but can be |
| | modified by the developer of the database system). |
| S | Refers to a system table, that cannot be modified by the end-user/ |
| | customer (e.g., but can be modified by the developer of the |
| | database system). |

In some implementations, the container is a package for the application code (which in this example is a database instance), configurations, dependencies, and the like, such that the package can be provided to a cloud platform to enable the cloud platform to virtualize and run the application instance. Examples of containers include Docker, Kubernetes, and the like.

At 214, a user interface, such as a dashboard or service provider cockpit (SPC), is generated for the development client being refreshed. For example, a dashboard (or cockpit) for the development client may be implemented as a web-based interface and provides access to functions for configuring/managing applications, services, and subaccounts as well as manage resources, services, security, monitor application metrics, and perform actions on cloud-based applications.

At 216, tasks may be run to create roles for the client and authorizations. In response to the client being created as part of the client refresh, the task lists may be run to create, for example, roles for the development client and authorizations for the development client. For example, created role for the development client may be a role as a database instance while the authorization may include allowing access to specific data (which may be identified by the authorization). At this point in the process of FIG. 2, the client is created and includes some basic configuration information, such as the S and E tables, allow list, a user interface, and roles and authorizations for the client.

Given that a basic configuration of the client is in place, the process may proceed, at 220, with recovering some of the customizations that may be retrieved from for example a repository and/or a configuration tool containing a central configuration. For example, this configuration tool may include a workspace having a specific end-user configuration for a database instance and/or a workspace providing a configuration for processes that span across different systems (e.g., configuration for an end-to-end business process). For example, the client (which is being refreshed) may correspond to a client at which the database instance is being developed. In this example, the development client may be configured with a baseline production system configuration (e.g., via 210) and then the customizations (from 220) may be applied. For example, the development client may recover (from, e.g., the noted configuration tool/repository) customization such as custom queries or other customization implemented at another client in the system landscape, such as a production client or test client where the baseline production system is hosted. For example, an end-user's customizations to the development client of the database instance may be stored and controlled via a repository or a central configuration tool (an example of which is SAP's Central Business Configuration tool, although other types of repositories or tools may be used as well). At this stage of the process of FIG. 2, the client being refreshed is rebuilt from a container 210 (e.g., copying certain system data and allow list(s)), includes a user interface, roles/authorizations, and customizing information (at 220) from another client of the database system, such as a production client of the database system instance.

At 222, master data may be recovered from another client, such as a test client where actual master data may be retrieved. Master data refers to data obtained from the end user's database tables, such as static data about suppliers or customers (e.g., name, phone numbers, and addresses) or employee master data with information such as employee name and social security number. By contrast, transaction data refers to more dynamic data such as data related to a transaction, such as the sale of a product. For example, the recovery may include application database tables with configuration information for the application (which in this example is a database instance and, in particular, a development client for the database instance); however, any end-user customizations to the application table may not be recovered (or, e.g., ignored) at 222. In some implementations, the master data such as the A (application) tables are retrieved from a test client, which refers to the client for the QA system of the database instance. At 224, the client being refreshed can then be setup for integration into the overall system landscape 192.

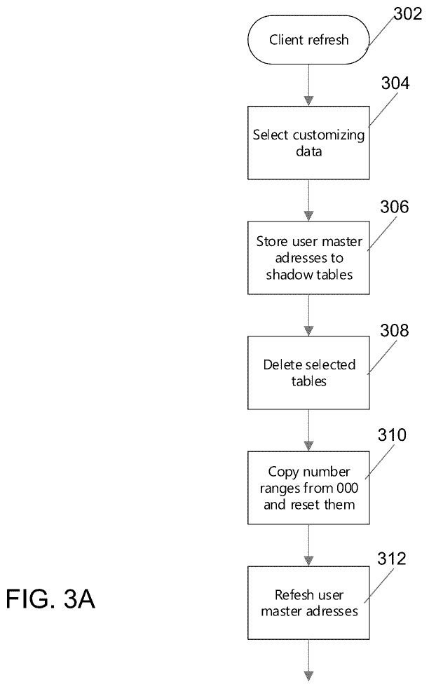

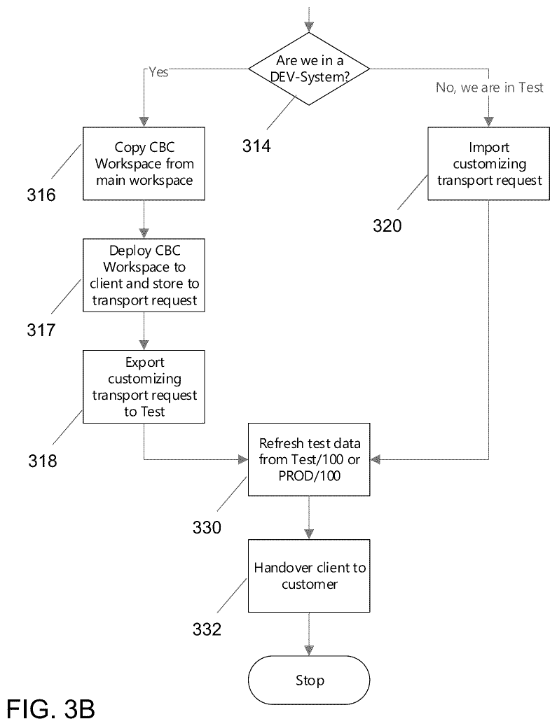

FIGS. 3A-3B depict a process to refresh a client, in accordance with some embodiments.

To refresh the client, such as the development client (which is used as a development system), a test client (which is used as a test system), and/or other type of client, there may be provided a process, such as the process of FIGS. 3A-3B to refresh the client. Instead of deleting the entire client being refreshed as noted at FIG. 2 above, the process of FIGS. 3A-3B to refresh the client may instead detect, delete, and redeploy certain data as depicted at FIGS. 3A-3B, in accordance with some embodiments. For example, during the life of a development client, certain data may change over time as part of the development of that client (e.g., due to customization and for other reasons), while other data does not change. Rather than delete the entire development client as part of the client refresh, certain data may be deleted (while other data associated with the client are kept) and the deleted data is then redeployed to the client being refreshed (“refreshed client”). For example, customizing data tables (which may be changed during the development of the development client) may be deleted and selectively redeployed to the refreshed client.

To illustrate further, the selection of data (e.g., the corresponding database tables) that are detected, deleted, and redeployed may include selecting data representing customization data for the client but not the corresponding database tables for the client which have not been customized and are more static, such as user master data, communications configurations, and data from a client's allow list. Alternatively, or additionally, the selection may include application data and data that are changed by a configuration tool, such as SAP's Central Business Configuration (CBC) tool, although other types of repositories or tools may be used as well. For example, the data selection may include tables accessed (e.g., modified) by the configuration tool of the client. These specific tables may be identified by reading from a staging area, which indicates any data changed by a configuration tool, such as the CBC. The identified (or selected) data may be redeployed by configuration tool as part of the client refresh. Any corresponding tables for user master data, communication configurations/arrangements, and data from a client's allow-list may not be selected for deployment to the refreshed client.

Before deletion of any data at the client being refreshed, user master addresses may be stored into a set of local shadow tables, which are excluded from the deletion. At this stage, certain data has been deleted from the client. However, number ranges in the remaining data may still need to be re-initialized so number range tables may be copied from a baseline client (which has few if any changes to the number range) to the client being refreshed and the copied ranges may be reset or reinitialized (e.g., to 0 or some other pre-determined value). To form a usable client, the user master addresses are restored from the shadow tables and redeployed to the refreshed client's user master addresses. This may also cause a refresh of the number ranges of the address tables of the user masters as well. At this point, the refreshed client is able to run with its user master data and with communications but the client has not been customized. In the case of a development client for example, a master workspace (e.g., which includes customizing data for one of the user's client) of the configuration tool may be copied into a current workspace for the refreshed client. And, this current workspace may be deployed to the refreshed client via a message or transport request. The redeployment of the customizing is from the workspace to the refreshed client. After the redeployment, a software change task list may be run as several details in customizing may have changed, so the software change task list may be used to clean up the customization configuration. A transport request (or other type of message) may be used to exported the workspace and import it into the refreshed client. In the case of a test client being refreshed for example, the contents of the message or transport request may be imported into the refreshed client. After this import to the refreshed client, data refresh tools may be used to import data into the refreshed client. The data refresh tools might be used to import the data into the refreshed client.

At 302-304, the client refresh controller 190 (as depicted at FIG. 1) may start with a selection of one or more customizing data tables. In some embodiments, the client refresh controller may receive an indication to refresh a client. For example, a development or test client may be rolled back to a base line configuration and thus the client needs to be refreshed. To illustrate further, client refresh controller may receive from the client 140A, cloud platform 110A, and/or configuration tool 194 an indication to refresh the client, and this indication may trigger the process at FIGS. 3A-3B.

At 306, the client refresh controller 190 may store user master addresses to a table, such as a shadow table. For example, the table(s) contain the addresses of user masters stored to the table, such as the shadow table. The user master address identifies the address of the user master record where the assignment of one or more roles is provided to one or more users. The roles may be used to determine authorization to access data and/or perform activities for the client being refreshed. The user master addresses may thus provide addresses of users or client devices using the system. The user master addresses may be stored with other custom data, such as vendor address, and the like. When importing, the addresses are copied to the original tables.

At 308, the client refresh controller 190 may delete the tables selected at 304. For example, the client refresh controller 190 may delete from the repository, such as the system landscape 192, the customizing data tables selected at 302.

At 310, the client refresh controller 190 may copy number ranges and reset the number ranges. For example, the client refresh controller 190 may copy number ranges from one or more database tables at a development client being refreshed. The number ranges may be for example an invoice number range, a product sold ID, and/or the like. The number ranges may be copied from one or more database tables and reset to a predetermined value (e.g., 0) in one or more tables. For example, the number ranges may be a list of increasing numbers with a name, a lower value, a higher value, and an actual value and may be associated (or stored with) application data. Rather than copy static application data from an application table, the number range (e.g., upper and lower limit) are copied and used to refresh the client.

At 312, the client refresh controller 190 may refresh the user master addresses by retrieving the user master addresses them from the shadow tables where the user master addresses were stored at 304. The deletion at 306 deleted the user master addresses, so here the user master addresses are retrieved and inserted back into the client being refreshed (“refreshed client”).

At 314, the client refresh controller 190 determines whether the client being refreshed is for a development system or a test system. In the case of a test client, the client refresh controller 190 may, at 320, import the contents of a transport request. For example, the transport request may include the contents of a workspace at a repository or configuration tool (such as configuration tool 194), and the workspace may include customizations performed on the test client. In some implementations, a development client is allowed to create, modify, and release a transport request but a test client is only allowed to import data from the transport request.

In the case of development client is determined to be the refreshed client at 314 (“Yes”), the client refresh controller 190 may, at 316, copy a master workspace (e.g., which includes customizing information for one of the user's client) of the configuration tool, such as the CBC. At the configuration tool 194, a copy of workspace may be copied into a current workspace for the development client. This workspace may include specific end-user configurations for the development client.

At 317, the client refresh controller 190 may deploy the copied workspace to the client and a transport request is stored. For example, the current workspace copied at 314 may be deployed to the development client (which is being refreshed) via a message, such as a transport request. At 318, the client refresh controller 190 may send (or cause the system landscape to send) a transport request (which includes the workspace) to the client. The transport request (or other type of message) may be used to export the workspace and import it into the client being refreshed.

At 330, test data is refreshed from the test client or production client. For example, test data used by the development client or the test client may be refreshed by copying the data from a test or production client. Moreover, the redeployment may move the customizing data from the workspace to the refreshed development client. After the redeployment to a development system, a software change task list may check to audit whether the customizing data received via the message or transport request has changed, so the software change task list may be used to clean up the customization configuration. At 330, the contents of the message or transport request may be imported to the client being refreshed. After this import to the client, data refresh tool may be used to import data into the client. The data refresh tool imports the data into the client, so a baseline client, such as baseline test client (or a baseline development client) may be used. At 332, the client refresh controller 190 may handover the client being refreshed to an end-user for usage.

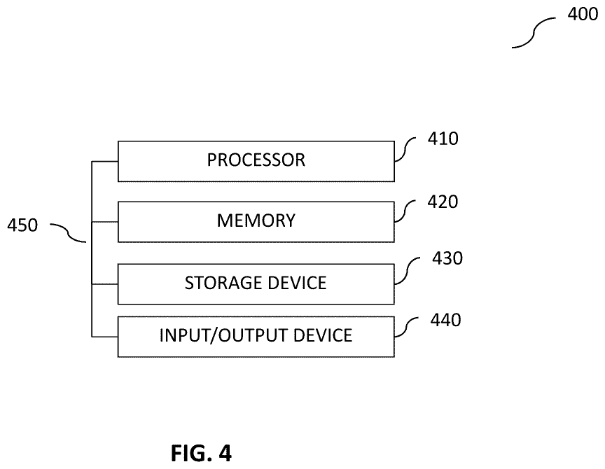

In some implementations, the current subject matter may be configured to be implemented in a system 400, as shown in FIG. 4. For example, the client refresh controller 190, system landscape, databases, and/or other aspects disclosed herein may be at least in part physically comprised on system 400. To illustrate further system 400 may further an operating system, a hypervisor, and/or other resources, to provide virtualize physical resources (e.g., via virtual machines). The system 400 may include a processor 410, a memory 420, a storage device 430, and an input/output device 440. Each of the components 410, 420, 430 and 440 may be interconnected using a system bus 450. The processor 410 may be configured to process instructions for execution within the system 400. In some implementations, the processor 410 may be a single-threaded processor. In alternate implementations, the processor 410 may be a multi-threaded processor.

The processor 410 may be further configured to process instructions stored in the memory 420 or on the storage device 430, including receiving or sending information through the input/output device 440. The memory 420 may store information within the system 400. In some implementations, the memory 420 may be a computer-readable medium. In alternate implementations, the memory 420 may be a volatile memory unit. In yet some implementations, the memory 420 may be a non-volatile memory unit. The storage device 430 may be capable of providing mass storage for the system 400. In some implementations, the storage device 430 may be a computer-readable medium. In alternate implementations, the storage device 430 may be a floppy disk device, a hard disk device, an optical disk device, a tape device, non-volatile solid state memory, or any other type of storage device. The input/output device 440 may be configured to provide input/output operations for the system 400. In some implementations, the input/output device 440 may include a keyboard and/or pointing device. In alternate implementations, the input/output device 440 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method, comprising: receiving, by a client refresh controller, an indication to refresh a client; in response to the received indication triggering the refresh of the client, the refresh comprising: selecting, by the client refresh controller, at least a first data table including client customization data for a client being refreshed; storing, by the client refresh controller, at least one user master address to a temporary table; in response to the selecting and storing, deleting, by the client refresh controller, at least the first table selected by the client refresh controller; in response to the deleting, retrieving, by the client refresh controller, the at least one user master address from the temporary table and inserting the at least one user master address into the client; copying, by the client refresh controller, a master workspace; and deploying, by the client refresh controller, the master workspace to the client via a transport request.

Example 2: The computer-implemented method of Example 1, wherein the client comprises a development client for a database instance and/or a test client for the database.

Example 3: The computer-implemented method of Example 1 or 2, wherein the first data table including the client customization data is selected from a system landscape, wherein the client customization data is customized for or by an end-user of the client being refreshed.

Example 4: The computer-implemented method of any of Examples 1-3, wherein the at least one user master address identifies one or more user roles with respect to authorization to access data and perform activities for the client being refreshed.

Example 5: The computer-implemented method of any of Examples 1-4, wherein the first table is deleted from a system landscape, and wherein the at least one user master address is inserted into the client at the system landscape.

Example 6: The computer-implemented method any of Examples 1-5 further comprising: in response to the deleting, copy at least a number range into the client at a system landscape.

Example 7: The computer-implemented method of any of Examples 1-6, wherein the copying, by the client refresh controller, the master workspace further comprises copying the master workspace at a configuration tool, wherein the master workspace includes customizing information for the client.

Example 8: The computer-implemented method of any of Examples 1-7, further comprising: importing the transport request into the client; refresh test data into the client; and handing over the client for use as a test client or a development client.

Example 9: A system comprising: at least one processor; and at least one memory including program code, which when executed by the at least one processor causes operations comprising: receiving, by a client refresh controller, an indication to refresh a client; in response to the received indication triggering the refresh of the client, the refresh comprising: selecting, by the client refresh controller, at least a first data table including client customization data for a client being refreshed; storing, by the client refresh controller, at least one user master address to a temporary table; in response to the selecting and storing, deleting, by the client refresh controller, at least the first table selected by the client refresh controller; in response to the deleting, retrieving, by the client refresh controller, the at least one user master address from the temporary table and inserting the at least one user master address into the client; copying, by the client refresh controller, a master workspace; and deploying, by the client refresh controller, the master workspace to the client via a transport request.

Example 10: The system of Example 9, wherein the client comprises a development client for a database instance and/or a test client for the database.

Example 11: The system of any of Examples 9-10, wherein the first data table including the client customization data is selected from a system landscape, wherein the client customization data is customized for or by an end-user of the client being refreshed.

Example 12: The system of any of Examples 9-11, wherein the at least one user master address identifies one or more user roles with respect to authorization to access data and perform activities for the client being refreshed.

Example 13: The system of any of Examples 9-12, wherein the first table is deleted from a system landscape, and wherein the at least one user master address is inserted into the client at the system landscape.

Example 14: The system of any of Examples 9-13 further comprising: in response to the deleting, copy at least a number range into the client at a system landscape.

Example 15: The system of any of Examples 9-14, wherein the copying, by the client refresh controller, the master workspace further comprises copying the master workspace at a configuration tool, wherein the master workspace includes customizing information for the client.

Example 16: The system of any of Examples 9-15, further comprising: importing the transport request into the client; refresh test data into the client; and handing over the client for use as a test client or a development client.

Example 17: A non-transitory computer-readable storage medium including program code, which when executed by at least one processor causes operations comprising: receiving, by a client refresh controller, an indication to refresh a client; in response to the received indication triggering the refresh of the client, the refresh comprising: selecting, by the client refresh controller, at least a first data table including client customization data for a client being refreshed; storing, by the client refresh controller, at least one user master address to a temporary table; in response to the selecting and storing, deleting, by the client refresh controller, at least the first table selected by the client refresh controller; in response to the deleting, retrieving, by the client refresh controller, the at least one user master address from the temporary table and inserting the at least one user master address into the client; copying, by the client refresh controller, a master workspace; and deploying, by the client refresh controller, the master workspace to the client via a transport request.

Example 18: The non-transitory computer-readable storage medium of Example 17, wherein the client comprises a development client for a database instance and/or a test client for the database.

Example 19: The non-transitory computer-readable storage medium of any of Examples 17-18, wherein the first data table including the client customization data is selected from a system landscape, wherein the client customization data is customized for or by an end-user of the client being refreshed.

Example 20: The non-transitory computer-readable storage medium of any of Examples 17-19, wherein the at least one user master address identifies one or more user roles with respect to authorization to access data and perform activities for the client being refreshed.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving, by a client refresh controller, an indication to refresh a client;
in response to the received indication triggering the refresh of the client, the refresh comprising:
selecting, by the client refresh controller, at least a first data table including client customization data for a client being refreshed;
storing, by the client refresh controller, at least one user master address to a temporary table;
in response to the selecting and storing, deleting, by the client refresh controller, at least the first table selected by the client refresh controller;
in response to the deleting, retrieving, by the client refresh controller, the at least one user master address from the temporary table and inserting the at least one user master address into the client;
copying, by the client refresh controller, a master workspace; and
deploying, by the client refresh controller, the master workspace to the client via a transport request.

2. The computer-implemented method of claim 1, wherein the client comprises a development client for a database instance and/or a test client for the database.

3. The computer-implemented method of claim 1, wherein the first data table including the client customization data is selected from a system landscape, wherein the client customization data is customized for or by an end-user of the client being refreshed.

4. The computer-implemented method of claim 1, wherein the at least one user master address identifies one or more user roles with respect to authorization to access data and perform activities for the client being refreshed.

5. The computer-implemented method of claim 1, wherein the first table is deleted from a system landscape, and wherein the at least one user master address is inserted into the client at the system landscape.

6. The computer-implemented method of claim 1 further comprising:
in response to the deleting, copy at least a number range into the client at a system landscape.

7. The computer-implemented method of claim 1, wherein the copying, by the client refresh controller, the master workspace further comprises copying the master workspace at a configuration tool, wherein the master workspace includes customizing information for the client.

8. The computer-implemented method of claim 1, further comprising:
importing the transport request into the client;
refresh test data into the client; and
handing over the client for use as a test client or a development client.

9. A system comprising:
at least one processor; and
at least one memory including program code, which when executed by the at least one processor causes operations comprising:
receiving, by a client refresh controller, an indication to refresh a client;
in response to the received indication triggering the refresh of the client, the refresh comprising:
selecting, by the client refresh controller, at least a first data table including client customization data for a client being refreshed;
storing, by the client refresh controller, at least one user master address to a temporary table;
in response to the selecting and storing, deleting, by the client refresh controller, at least the first table selected by the client refresh controller;
in response to the deleting, retrieving, by the client refresh controller, the at least one user master address from the temporary table and inserting the at least one user master address into the client;
copying, by the client refresh controller, a master workspace; and
deploying, by the client refresh controller, the master workspace to the client via a transport request.

10. The system of claim 9, wherein the client comprises a development client for a database instance and/or a test client for the database.

11. The system of claim 9, wherein the first data table including the client customization data is selected from a system landscape, wherein the client customization data is customized for or by an end-user of the client being refreshed.

12. The system of claim 9, wherein the at least one user master address identifies one or more user roles with respect to authorization to access data and perform activities for the client being refreshed.

13. The system of claim 9, wherein the first table is deleted from a system landscape, and wherein the at least one user master address is inserted into the client at the system landscape.

14. The system of claim 9 further comprising:
in response to the deleting, copy at least a number range into the client at a system landscape.

15. The system of claim 9, wherein the copying, by the client refresh controller, the master workspace further comprises copying the master workspace at a configuration tool, wherein the master workspace includes customizing information for the client.

16. The system of claim 9, further comprising:
importing the transport request into the client;
refresh test data into the client; and
handing over the client for use as a test client or a development client.

17. A non-transitory computer-readable storage medium including program code, which when executed by at least one processor causes operations comprising:
receiving, by a client refresh controller, an indication to refresh a client;
in response to the received indication triggering the refresh of the client, the refresh comprising:
selecting, by the client refresh controller, at least a first data table including client customization data for a client being refreshed;
storing, by the client refresh controller, at least one user master address to a temporary table;
in response to the selecting and storing, deleting, by the client refresh controller, at least the first table selected by the client refresh controller;
in response to the deleting, retrieving, by the client refresh controller, the at least one user master address from the temporary table and inserting the at least one user master address into the client;
copying, by the client refresh controller, a master workspace; and
deploying, by the client refresh controller, the master workspace to the client via a transport request.

18. The non-transitory computer-readable storage medium of claim 17, wherein the client comprises a development client for a database instance and/or a test client for the database.

19. The non-transitory computer-readable storage medium of claim 17, wherein the first data table including the client customization data is selected from a system landscape, wherein the client customization data is customized for or by an end-user of the client being refreshed.

20. The non-transitory computer-readable storage medium of claim 17, wherein the at least one user master address identifies one or more user roles with respect to authorization to access data and perform activities for the client being refreshed.
